(19) United States
(12) Patent Application Publication
(10) Pub. No.: US 2025/0228150 A1
(43) Pub. Date: Jul. 17, 2025

(54) PUSH-PULL GARDEN HAND TOOL

(71) Applicant: GARDEN PROS HOLDINGS LLC, Orem, UT (US)

(72) Inventors: Gloria Jean Schultz, Tucson, AZ (US); Elton K Ongley, Sahuarita, AZ (US); Don Schulthies, Bountiful, UT (US)

(21) Appl. No.: 18/834,206

(22) PCT Filed: Jun. 22, 2022
(86) PCT No.: PCT/US22/34614

§ 371 Date: Jul. 29, 2024

Related U.S. Application Data
(60) Provisional application No. 63/213,210, filed on Jun. 22, 2021.

(51) Int. Cl. A01B 1/08

(52) U.S. Cl. CPC A01B 1/08

(57) ABSTRACT

A garden hand tool is described to enable easier gardening with increased gardening and landscaping functionality. The hand tool has a head that provides multiple functions. The handle can provide improved ergonomics and direct the force applied by the user to the head for improved operation. The shaft of the tool can have a curve to improve the ergonomics of the tool.

### RELATED APPLICATIONS

This application is a nonprovisional application based on, and claims priority to, U.S. Provisional Application No. 63/213,210 filed Jun. 22, 2021.

### FIELD

Descriptions are generally related to garden tools, and more particular descriptions are related to a push-pull handheld garden tool.

### BACKGROUND

There are numerous versions of garden hand tools, with a variety of heads. The heads of the tools are connected via a shaft to a handle the user will grasp to use the tool. The function of many tools is limited to a single function. The connection of the handles to the heads in many tools is not ergonomic, but can cause stress on the user's hand or wrist as the tool is used.

### BRIEF DESCRIPTION OF THE DRAWINGS

The following description includes discussion of figures having illustrations given by way of example of an implementation. The drawings should be understood by way of example, and not by way of limitation. As used herein, references to one or more examples are to be understood as describing a particular feature, structure, or characteristic included in at least one implementation of the invention. Phrases such as “in one example” or “in an alternative example” appearing herein provide examples of implementations of the invention, and do not necessarily all refer to the same implementation. However, they are also not necessarily mutually exclusive.

FIGS. 1A-1C illustrate an example of a hand tool with a V-shaped blade and a looped handle.

FIG. 2 illustrates an example of a hand tool with a shaft with a curve.

FIG. 3 illustrates an example of a hand tool with a curved shaft.

FIG. 4 illustrates an example of a hand tool with a V-shaped blade with a sharpened notch.

FIG. 5 illustrates an example of a hand tool with a V-shaped blade and an open handle.

FIG. 6 illustrates an example of a hand tool with a shaft extending into arms that extend to the blade.

Descriptions of certain details and implementations follow, including non-limiting descriptions of the figures, which may depict some or all examples, and well as other potential implementations.

### DETAILED DESCRIPTION

As described herein, a garden hand tool is described to enable easier gardening with increased gardening and landscaping functionality. The hand tool has a head that provides multiple functions. The handle can provide improved ergonomics and direct the force applied by the user to the head for improved operation. The shaft of the tool can have a curve to improve the ergonomics of the tool.

The descriptions include examples of a hand tool having a head that enables a push-pull operation. The head can be generally in accordance with what is described in U.S. Pat. No. 8,708,057. The head (the “Skidger head”) can differ from what is described in that patent in that the head can connect in the same way as described in that patent to a shaft to the handle, or can have alternative connections to a handle in accordance with the examples below. SKIDGER is a registered trademark of Skidger LLC, and is used for purposes of identification.

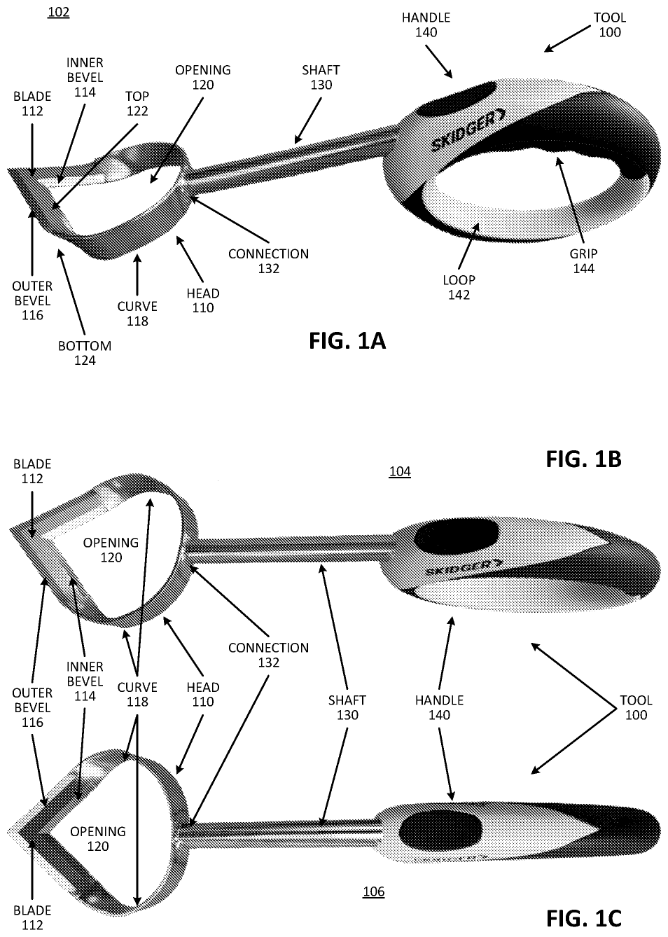

FIGS. 1A-1C illustrate an example of a push-pull hand tool with a V-shaped blade and a looped handle.

FIG. 1A provides view 102 of tool 100, which illustrates a handheld garden tool with a Skidger head. Tool 100 has a blade portion with a sharpened tip, with the blades sharpened in front and back. The blade portion extends continuously into arm portions that have a continuous curve up to the shaft portion. The shaft portion connects to an ergonomic handle. The handle can be a closed loop handle. In one example, the handle has contours to allow gripping, with the contours spaced in accordance with the spacing of the fingers of a hand.

As illustrated in view 102, head 110 includes blade 112, which is a blade made of two blade portions. Blade 112 illustrates top 122 and bottom 124 for reference. Top 122 is the top of the blade when the plane of blade 112 rests on the ground. Bottom 124 is the side of blade 112 opposite top 122. Blade 112 has inner bevel 114, which is a sharpened edge extending from top 122 toward bottom 124, on an inside of the tool, or toward opening 120, which represents an opening formed by the curved arms extending from blade 112. Outer bevel 116 extends from top 122 toward bottom 124 on the leading edge of tool 100, on the opposite side of blade 112 from opening 120.

Head 110 is a V-shaped head with a V-shaped point in blade 112. The V-shaped point of blade 112 is where the blade portions adjoin. Blade 112 can be two portions adjoining in a plane or approximately in a plane or adjoining through a plane of the blade if the portions adjoin at an angle instead of in a plane.

Head 110 includes curves 118 or curved twists from blade 112 to shaft 130. Curves 118 represent arms that extend from blade 112 via a curvature or twisting of the arm portions, connecting blade 112 to shaft 130 or the shaft portion. Curve 118 transitions the strip constituting the blade portion from its plane up via a continuous curve to shaft 130. It will be observed how the continuous curving of curves 118 interface up and around to the handle portion without 90 degree angles or other discrete bends (i.e., a bend at a measurable angle, as opposed to a continuous curve). Rather, there is a more elliptical curvature.

Head 110 can have first and second arm portions, being extensions, respectively, of first and second blade portions that form blade 112. The arm portions extend the strips of metal of blade 112 in a continuous curve without right angles to the shaft portion, with inner curve surfaces or inner surfaces of curve 118 being surfaces of the strips of metal that form top 122 or the top blade surface, and outer curve surfaces of curve 118 being surfaces of the strips of metal that form bottom 124 or the bottom blade surface.

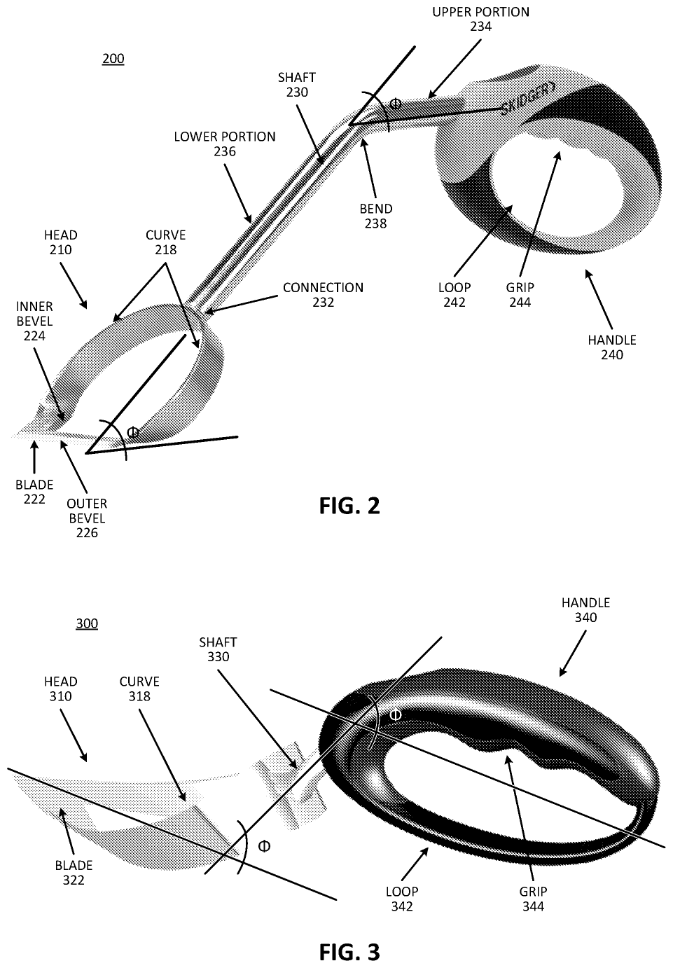

Each arm portion can be an extension of the metal strip of blade 112 curved between the two sides of the blade to transfer force directly to blade 112 from handle 140 through shaft 130 without introducing stress points from right-angles in the arms between head 110 and handle 140. The curved twists of curves 118 cause the plane of the blade portions to intersect with a longitudinal axis of shaft 130 between approximately 30 and 50 degrees, as described in more detail with respect to FIG. 2.

In one example, curve 118 can be considered to be achieved through an “inner arc” and an “outer arc”, corresponding to the inward-facing blade edge (e.g., the one facing opening 120) and the outward-facing blade edge, respectively. In one example, inner arc has a tighter radius than the outer arc. The inner arc and the outer arc are continuously curved, without discrete angles or bends in the arm portions. The curve of the outer arc is longer than curve of the inner arc, meaning it has a larger radius or moment. Thus, the arcs of the two sides (the two arms) of the tool form an elliptical region inside the open region of opening 120. The ellipse area by the two outer arcs can be larger than the elliptical area formed by the two inner arcs. One advantage to the arcs is the improved transfer of force applied to the handle portion over comparable tools that use 90 degree (or some other discrete angle) bends. In one example, there are no flat surfaces on the arm portions from where they connect to the shaft portion. This is one example of an understanding of a continuous curve. Another advantage of the two arcs of different radius (or moment, considering the arcs to be elliptical rather than circular), is that the tool can be used to scoop and spread material, because when held at the right angle the tool allows for the temporary capture of material.

In one example, handle 140 has a closed loop, represented by loop 142. Thus, the portion on top of the handle where a user grasps the handle with the hand, continues in a loop around an area where a user's fingers would grasp around the top portion of handle 140. Loop 142 can thus provide a loop around the grasping fingers of the user. In one example, handle 140 includes grip or contours that provide improved grip for the user's fingers. The contours of grip 144 can be spaced to have depression where the user's fingers would be, and higher portions in the spacing between the fingers, to allow natural separation between where fingers when the user grasps handle 140. Grip 144 can provide increased comfort and eases of use of tool 100.

View 102 illustrates connection 132, which is the point where shaft 130 connects to head 110. In one example, head 110 is a single piece of metal, bent around with curves 118 to for blade 112. Connection 132 can be a weld between shaft 130 and the metal strip or metal strips of head 110. In one example, shaft 130 is connected to head 110 through a rivet or screw that extends through the metal strip of head 110 up into shaft 130, along its longitudinal axis.

FIG. 1B illustrates a perspective view of FIG. 1A, indicated as view 104 of tool 100. View 104 illustrates the same components described above with respect to view 102. View 104 illustrates a different perspective of the curvature of the arm portions provided by curves 118 to connect the portions of blade 112 to shaft 130. Connection 132 illustrates a weld of shaft 130 to head 110 (i.e., the Skidger head). As an alternative to welding the shaft to the head, the head can have a hole at the connection point with the shaft, and a bolt can be secured from inside opening 120 into shaft 130. For example, shaft 130 can have threading on the inside of the shaft to receive a bolt to secure shaft 130 to head 110.

FIG. 1C illustrates a perspective view of FIG. 1A, indicated as view 106 of tool 100. View 106 illustrates the same components described above with respect to view 102. View 106 illustrates the curvature of the arm portions connected to blade 112 from yet another angle. Tool 100 represents shaft 130 as a round piece of metal welded to the arm portions of head 110. In one example, blade 112 can be made with a single strip of metal, with one side of the metal strip curved into one arm portion and the other side of the metal strip curved into the other arm. The metal can be joined at the blade tip. Alternatively, two different pieces of metal can be curved, and then be joined at both the blade tip and on the arm portions. Rather than a round rod, in one example, shaft 130 can have a square or rectangular cross section.

FIG. 2 illustrates an example of a hand tool with a shaft with a curve. The diagram provides a perspective view of tool 200, which is a push-pull hand tool. Tool 200 provides an example of a tool in accordance with tool 100, where tool 200 specifically illustrates a curve in the shaft.

Tool 200 includes head 210 with blade 222 made up of two blade portions that extend up into arms portions that extend in a continuous curve to shaft 230. The continuous curve is illustrated by curves 218. Blade 222 has inner bevel 224 as a sharpening of the inner portion of the blade toward the opening, and outer bevel 226 as a sharpening of the outer portion of the blade away from the opening. Inner bevel 224 is the leading edge of the sharpened blade when tool 200 is pulled, and outer bevel 226 is the leading edge of the sharpened blade when tool 200 is pushed.

Tool 200 includes handle 240, which can have a closed loop as illustrated by loop 242. Alternatively, handle 240 can be straight or can be an open loop. Handle 240 can have a contoured grip as illustrated by grip 244. Alternatively, handle 240 can have a non-contoured handle.

Tool 200 includes shaft 230 connected between handle 240 and head 210. In one example, shaft 230 includes a curve, represented by bend 238. Bend 238 changes the angle at which handle 240 is connected to head 210, as seen with tool 200. Tool 200 can have connection 232 to connect shaft 230 to head 210. Connection 232 can be in accordance with any connection described above.

When the user pushes the tool, there is a force vector applied from handle 240, which will be along the longitudinal axis of upper portion 234. The longitudinal axis of upper portion 234 intersects a longitudinal axis of lower power 236 at angle phi (ϕ). Thus, the force vector applied by the user to handle 240 intersects with the longitudinal axis of the portion of shaft 230 that connects to head 210 at angle phi.

Blade 222 can be a flat strip of metal in a plane. In an alternative example, blade 222 is not in a single plane, but the two portions of the blade connect at an angle. In such an implementation, the blade portions will start above the plane of the blade, intersect the plane, and connect below the plane. The plane is still the general plane of the blade even if the blade portions are connected at angles relative to the plane.

The plane of blade 222 intersects with the longitudinal axis of lower portion 236 at approximately the same angle as the handle portion. Thus, both angles are illustrated as phi. The angle does not need to be exactly the same. In one example, the angle at which the blade intersects shaft 230 can be 5 to 10 degrees different than the angle at which handle 240 intersects with shaft 230. The 5 to 10 degrees can be 5 to 10 degrees smaller on upper portion 234, making a smaller angle on the top portion at the handle.

While the angles can be different, there is an advantage to having the angles the same or nearly the same, in that force applied from handle 240 will be applied in a vector that is the same or approximately the same as a vector of motion of blade 222. Thus, the angle of curves 218 to shaft 230 can provide for ergonomic use, and matching the angle with bend 238 can maximize the application of force from handle 240 to blade 222 while maintaining the ergonomics of the use.

Tool 200 illustrates a bend shaft 230, which connects to handle 240, as opposed to the straight shaft of tool 100, which connects to handle 140 at an angle. In general, the angle of the blade relative to the shaft can be approximately 25-50 degrees. Considering the plane of the handle to be where a plane would intersect the back and front portions of the generally elliptical opening in the handle, the plane of the handle can intersect the shaft at an angle of anywhere between approximately 10 degrees to an angle that equals the angle at which the shaft intersects the blade portion (e.g., 25-50 degrees). Such an angle would make the plane of the handle parallel to the plane of the blade portion.

An advantage to having the plane of the handle parallel to the plane of the blade portion is that force applied to the handle would be transferred very efficiently to the tip of the blade, where the two portions of the blade intersect. An advantage to having the handle at an offset relative to the plane of the blade portion (generally, having an angle with respect to the shaft that is less than the angle of the shaft relative to the blade portion) is that the tip blade and also the tip will remain at an angle relative to the application of force of the handle. Such operation can drive the blade into the ground to the roots of the weeds when pushing, and can lift the dirt and weeds when pulling. Both configurations have advantages.

FIG. 3 illustrates an example of a hand tool with a curved shaft. The diagram provides a perspective view of tool 300, which is a push-pull hand tool. Tool 300 provides an example of a tool in accordance with tool 100, where tool 300 specifically illustrates a curved shaft.

Tool 300 includes head 310 connected to handle 340 via shaft 330. Head 310 includes blade 322, which extends into curves 318 to connect to shaft 330. Shaft 330 can be connected to head 310 in accordance with any example described above. In one example, handle 340 includes contoured grip 344. In one example, handle 340 is a closed loop, represented by loop 342. In one example, handle 340 is an open loop.

It will be observed that tool 300 employs similar angle matching as tool 200, where the plane of the handle is approximately parallel with the plane of the blade portion, with a short shaft. Instead of being a long shaft with a bend or curve in it, shaft 330 can have a curvature to it to enable connecting to handle 340 to head 310. In this diagram or in any of the other diagrams, the shaft can extend some way or most of the way into the handle. The longer the shaft extends into the handle, the more secure the handle will be to the tool.

Shaft 330 can be longer than what is shown with shaft 330, and be continuously curved, such as with an ‘S’ curve to connect head 310 to handle 340. Shaft 330 can lack straight portions that are present in shaft 230 of tool 200, or have significantly shorter straight portions.

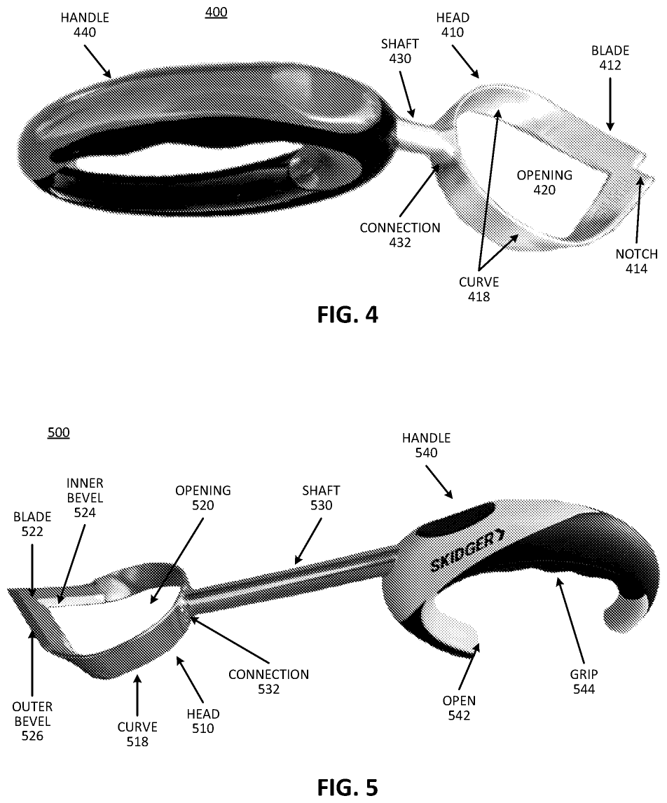

FIG. 4 illustrates an example of a hand tool with a V-shaped blade with a sharpened notch. The diagram provides a perspective view of tool 400, which is a push-pull hand tool. Tool 400 provides an example of a tool in accordance with tool 100, where tool 400 specifically illustrates a notched blade.

Tool 400 includes head 410 connected to handle 440 via shaft 430. Head 410 includes blade 412, which extends into curves 418 to connect to shaft 430 at connection 432. Curves 418 create an inner open space or opening 420, which represents a space or opening through head 410. Shaft 430 can be connected to head 410 in accordance with any example described above. In one example, handle 440 includes a contoured grip. In one example, handle 440 is a closed loop. In one example, handle 440 is an open loop.

In accordance with an example tool 400, head 410 can be in accordance with any example described. In one example, as illustrated, head 410 can have a notch instead of a tip on the blade portion, as illustrated by notch 414. Notch 414 can be sharpened, with bevels on both sides of the opening of the notch.

Tool 400 represents another example of a connection of handle 440 to head 410, with another example of a shaft, shown by shaft 430. Shaft 430 can provide any angle of connection between handle 440 and head 410 described. In one example, shaft 430 connects to a different place in handle 440, and can extend out of handle 440 at a different angle to connect to head 410.

In general, the shaft of a hand tool in accordance with any tool described can be approximately 1 or 2 inches, to 6 to 8 inches. Different shaft lengths can have different advantages. Longer shafts can benefit taller individuals as well as supporting uses in barrels or planters where there can be significant plant foliage extending up. Shorter shafts can be very useful in garden beds or under bushes. Of course, both longer shafts and shorter shafts can be used in any of the tools described herein.

In one example, notch 414 enables the weeding of weeds with larger roots. Notch 414 provides a recess in blade 412 where a root can catch, and enable the application of force by the tool against the root to cut it more easily. Notch 414 can provide a user with a “feel” for where a weed is, and catch the weed to enable the user to cut it with an extra push. The shape and size of notch 414 are variable, and can be changed from one implementation to another. For purposes of example, and not by way of limitation, the notch can itself be V-shaped (a V in the opposite direction of the V shape of the blade), U-shaped, a semicircle, an arc, or another shape. The depth of the notch can also be variable. In one example, the depth of the notch is between approximately 1/10 to ¼ the width of the blade. Other depth of notch can also be used. In one example, the pointed tip is replaced with a flattened portion that could be as wide as the notch shown, but simply be flat rather than notching back into the blade.

FIG. 5 illustrates an example of a hand tool with a V-shaped blade and an open handle. The diagram provides a perspective view of tool 200, which is a push-pull hand tool. Tool 500 provides an example of a tool in accordance with tool 100, where tool 500 specifically illustrates an open handle.

Tool 500 has a blade portion with a sharpened tip, with the blades sharpened in front and back. The blade portion extends continuously into arm portions that have a continuous curve up to the shaft portion. The shaft portion connects to an ergonomic handle. The handle can be a closed loop handle. In one example, the handle has contours to allow gripping, with the contours spaced in accordance with the spacing of the fingers of a hand.

As illustrated, head 510 includes blade 522, which is a blade made of two blade portions. Blade 522 has inner bevel 524, which is a sharpened edge extending from the top to the bottom of the blade, on an inside of the tool, or toward opening 520, which represents an opening formed by the curved arms extending from blade 522. Outer bevel 526 extends from the top to the bottom on the outer edge or outside edge of tool 500, on the opposite side of blade 522 from opening 520.

Head 510 includes curves 518 or curved twists from blade 522 to shaft 530. Curves 518 represent arms that extend from blade 522 via a curvature or twisting of the arm portions, connecting blade 522 to shaft 530 or the shaft portion. Curve 518 transitions the strip constituting the blade portion from its plane up via a continuous curve to shaft 530.

In one example, handle 540 is not a closed loop. Open 542 represents the fact that handle 540 does not completely close around the user's fingers when the user grasps handle 540. Handle 540 can include curved front and back portions without fully connecting in a loop. An advantage to the full loop is to protect the user's fingers and hand when using the tool. An advantage to the open loop or the curved handle is that the fit may be more comfortable when wearing gloves or for people with larger hands.

In one example, handle 540 includes grip or contours that provide improved grip for the user's fingers. The contours of grip 544 can be spaced to have depression where the user's fingers would be, and higher portions in the spacing between the fingers, to allow natural separation between where fingers when the user grasps handle 540. Grip 544 can provide increased comfort and eases of use of tool 500.

Tool 500 illustrates connection 532, which is the point where shaft 530 connects to head 510. In one example, head 510 is a single piece of metal, bent around with curves 518 to for blade 522. Connection 532 can be a weld between shaft 530 and the metal strip or metal strips of head 510. In one example, shaft 530 is connected to head 510 through a rivet or screw that extends through the metal strip of head 510 up into shaft 530, along its longitudinal axis.

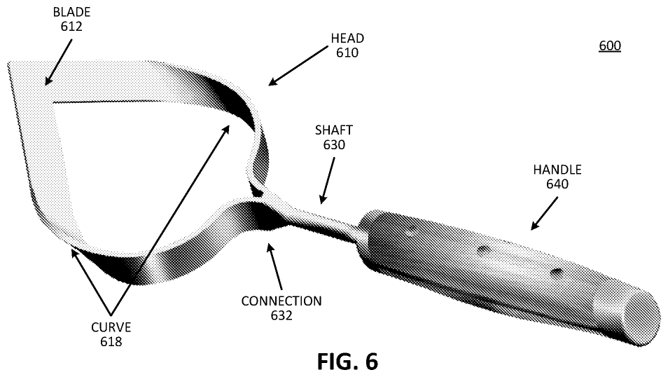

FIG. 6 illustrates an example of a hand tool with a shaft extending into arms that extend to the blade. The diagram provides a perspective view of tool 600, which is a push-pull hand tool. Tool 600 provides an example of a tool in accordance with tool 100, where tool 600 specifically illustrates a curve in the shaft.

Tool 600 includes head 610 with blade 612 made up of two blade portions that extend up into arms portions that extend in a continuous curve to shaft 630. The continuous curve is illustrated by curves 618. Blade 612 can be sharpened on the front and back of blade 612.

Tool 600 includes handle 640, which can be a handle in accordance with any described herein. Tool 600 illustrates a different type of handle. Handle 640 is more of a traditional handle, with a relatively straight portion for the user to grasp. While not specifically illustrated, shaft 630 can provide any angle of connection between handle 640 and head 610 described above.

Tool 600 illustrates a different type of connection between the shaft and the head. Connection 632 connects shaft 630 to head 610. Instead of a weld to a flat portion of the arms, or a bolt through a flat portion of the arms, connection 632 represents a curving of the arms or arm portions at the end of shaft 630. Shaft 630 can connect to the arm portions through a weld of shaft to the arm portions. The arms can have their inner surfaces welded together, and the connection also welded to shaft 630.

Alternatively, the arm portions of head 610 can curve up to have their inner surfaces facing each other, and shaft 630 can transition into a flat portion at the end of the shaft for connection to head 610. Then, the flat or flattened portion of shaft 630 can be positioned between the arm portions. The flat portion can be welded, or tool 600 can have a rivet or a bolt that extends through the two arm portions (i.e., where the two arm portions meet) and through the flat portion of the shaft to secure shaft 630 to head 610.

In accordance with the descriptions herein, in one aspect, a garden tool includes: a handle; a shaft portion with a first end connected to the handle; and a head connected to a second end of the shaft portion, the head having an with first and second blade portions of strips of metal that adjoin in a V-shaped point, the first and second blade portions adjoining in a plane, with top blade surface having an angled edge down to bottom blade surface; the head having first and second arm portions, being extensions, respectively, of the first and second blade portions, the first and second arm portions extending the strips of metal in a continuous curve without right angles from the first and second blade portions to the shaft portion, with inner curve surfaces of the continuous curves being surfaces of the strips of metal that form the top blade surface, and outer curve surfaces of the continuous curves being surface of the strips of metal that form the bottom blade surface.

In one example of the garden tool, the V-shaped point comprises two pieces of metal welded together at a point of the V. In accordance with any preceding example of the garden tool, the V-shaped point comprises a single piece of metal. In accordance with any preceding example of the garden tool, the V-shaped point comprises a notch instead of a point of the V. In accordance with any preceding example of the garden tool, the curved twists of the arm portions cause the plane of the blade portions to intersect with a longitudinal axis of the shaft portion at a first angle between approximately 30 and 50 degrees. In accordance with any preceding example of the garden tool, the shaft portion has a bend to cause a force vector applied from the handle to intersect the longitudinal axis of the shaft portion at second angle approximately the same as the first angle. In accordance with any preceding example of the garden tool, the second angle is between approximately 5 to 10 degrees smaller than the first angle. In accordance with any preceding example of the garden tool, the first angle and the second angle are approximately 40 degrees. In accordance with any preceding example of the garden tool, the shaft portion is curved to cause a force vector applied from the handle to intersect the longitudinal axis of the shaft portion at second angle approximately the same as the first angle. In accordance with any preceding example of the garden tool, the handle comprises a closed loop. In accordance with any preceding example of the garden tool, the handle comprises an open loop. In accordance with any preceding example of the garden tool, the handle comprises finger grips.

In accordance with the descriptions herein, in one aspect, a second garden tool includes: a handle; a shaft with a first end connected to the handle; and a head with two blade portions, the blade portions being flat metal strips adjoining in a plane of the blade portions to form a V-shaped head with the blade portions, each blade portion including a bevel on outside edges of the blade portion, with an angled edge from a first surface of the metal strips of the blade portion to a second surface of the blade portion, the beveled edges adjoining to form a point of the V-shaped head, the head including arm portions to connect the blade portions to the shaft, each arm portion being an extension of the metal strip of respective blade portions, each arm portion curved between the respective blade portion and the shaft to transfer force directly to the blade portion without introducing stress points from right-angles in the arm portions between the head and the handle, the respective curved twists extending the metal strip of each respective arm portion in a continuous curve without straight edges from the respective blade portion to the shaft; wherein the curved twists cause the plane of the blade portions to intersect with a longitudinal axis of the shaft between approximately 30 and 50 degrees.

In one example of the second garden tool, the shaft has a bend to cause a force vector applied from the handle to intersect the longitudinal axis of the shaft at second angle approximately the same as the first angle. In accordance with any preceding example of the second garden tool, the second angle is between approximately 5 to 10 degrees smaller than the first angle. In accordance with any preceding example of the second garden tool, the first angle and the second angle are approximately 40 degrees. In accordance with any preceding example of the second garden tool, the shaft is curved to cause a force vector applied from the handle to intersect the longitudinal axis of the shaft at second angle approximately the same as the first angle. In accordance with any preceding example of the second garden tool, the handle comprises a closed loop. In accordance with any preceding example of the second garden tool, the handle comprises an open loop. In accordance with any preceding example of the second garden tool, the handle comprises finger grips.

Besides what is described herein, various modifications can be made to the disclosed examples and implementations of the invention without departing from their scope. Therefore, the illustrations and examples herein should be construed in an illustrative, and not a restrictive sense. The scope of the invention should be measured solely by reference to the claims that follow.

1. A garden tool comprising:
a handle;
a shaft portion with a first end connected to the handle; and
a head connected to a second end of the shaft portion, the head having an with first and second blade portions of strips of metal that adjoin in a V-shaped point, the first and second blade portions adjoining in a plane, with top blade surface having an angled edge down to bottom blade surface; the head having first and second arm portions, being extensions, respectively, of the first and second blade portions, the first and second arm portions extending the strips of metal in a continuous curve without right angles from the first and second blade portions to the shaft portion, with inner curve surfaces of the continuous curves being surfaces of the strips of metal that form the top blade surface, and outer curve surfaces of the continuous curves being surface of the strips of metal that form the bottom blade surface.

2. The garden tool of claim 1, wherein the V-shaped point comprises two pieces of metal welded together at a point of the V.

3. The garden tool of claim 1, wherein the V-shaped point comprises a single piece of metal.

4. The garden tool of claim 1, wherein the V-shaped point comprises a notch instead of a point of the V.

5. The garden tool of claim 1, wherein the continuous curve of the arm portions cause the plane of the blade portions to intersect with a longitudinal axis of the shaft portion at a first angle between approximately 30 and 50 degrees.

6. The garden tool of claim 5, wherein the shaft portion has a bend to cause a force vector applied from the handle to intersect the longitudinal axis of the shaft portion at second angle approximately the same as the first angle.

7. The garden tool of claim 6, wherein the second angle is between approximately 5 to 10 degrees smaller than the first angle.

8. The garden tool of claim 5, wherein the first angle and the second angle are approximately 40 degrees.

9. The garden tool of claim 5, wherein the shaft portion is curved to cause a force vector applied from the handle to intersect the longitudinal axis of the shaft portion at second angle approximately the same as the first angle.

10. The garden tool of claim 1, wherein the handle comprises a closed loop.

11. The garden tool of claim 1, wherein the handle comprises an open loop.

12. The garden tool of claim 1, wherein the handle comprises finger grips.

13. A garden tool comprising:
a handle;
a shaft with a first end connected to the handle; and
a head with two blade portions, the blade portions being flat metal strips adjoining in a plane of the blade portions to form a V-shaped head with the blade portions, each blade portion including a bevel on outside edges of the blade portion, with an angled edge from a first surface of the metal strips of the blade portion to a second surface of the blade portion, the beveled edges adjoining to form a point of the V-shaped head, the head including arm portions to connect the blade portions to the shaft, each arm portion being an extension of the metal strip of respective blade portions, each arm portion curved between the respective blade portion and the shaft to transfer force directly to the blade portion without introducing stress points from right-angles in the arm portions between the head and the handle, the respective curved twists extending the metal strip of each respective arm portion in a continuous curve without straight edges from the respective blade portion to the shaft;
wherein the curved twists cause the plane of the blade portions to intersect with a longitudinal axis of the shaft between approximately 30 and 50 degrees.

14. The garden tool of claim 13, wherein the shaft has a bend to cause a force vector applied from the handle to intersect the longitudinal axis of the shaft at second angle approximately the same as the first angle.

15. The garden tool of claim 14, wherein the second angle is between approximately 5 to 10 degrees smaller than the first angle.

16. The garden tool of claim 14, wherein the first angle and the second angle are approximately 40 degrees.

17. The garden tool of claim 14, wherein the shaft is curved to cause a force vector applied from the handle to intersect the longitudinal axis of the shaft at second angle approximately the same as the first angle.

18. The garden tool of claim 13, wherein the handle comprises a closed loop.

19. The garden tool of claim 13, wherein the handle comprises an open loop.

20. The garden tool of claim 13, wherein the handle comprises finger grips.
